(19) United States
(12) Patent Application Publication
(10) Pub. No.: US 2010/0049104 A1
(43) Pub. Date: Feb. 25, 2010

(54) DEVICE FOR THE TREATMENT OF TINNITUS

(75) Inventors: Marco Lugli, Modena (IT); Stefano Parmigiani, Fidenza (IT); Romano Romani, Felino (IT)

Correspondence Address: HAMRE, SCHUMANN, MUELLER & LARSON, P.C., P.O. BOX 2902, MINNEAPOLIS, MN, 55402-0902, US

(73) Assignee: UNIVERSITA' DEGLI STUDI DI PARMA, Parma, PR (IT)

(21) Appl. No.: 12/523,791

(22) PCT Filed: Jan. 16, 2008
(86) PCT No.: PCT/EP08/50446

§ 371 Date: Jul. 20, 2009

(30) Foreign Application Priority Data
Jan. 18, 2007 (IT) UD2007A000009

(51) Int. Cl. A61H 1/00

(52) U.S. Cl. 601/47

(57) ABSTRACT

A device for the treatment of tinnitus, comprising generator means able to generate an audio signal, and transducer means connected to the generator means in order to reproduce the audio signal. The device also comprises filter means interposed between the generator means and the transducer means in order to filter and substantially suppress the audio signal at least in correspondence with an interval of frequencies around the dominant frequency (Ft) of tinnitus, so as to obtain a silent window (silent band) having a selected width or amplitude around said dominant frequency (Ft) of tinnitus.

### FIELD OF THE INVENTION

The present invention concerns a device for the treatment of tinnitus, also known as phantom sound, meaning the buzzing or whistling sensation, more or less persistent, that is heard in the absence of sounds arriving from the outside and which has a determinate subjective intensity (loudness) and a determinate dominant height or frequency (pitch).

### BACKGROUND OF THE INVENTION

The pathology of tinnitus is becoming an ever more extensive social problem. The person affected by this problem perceives a phantom sound which can become incapacitating. Epidemiological surveys reveal that the sensation caused by tinnitus is present in 5-15% of the human population. It is thought that tinnitus consists in an abnormal neural activity of the auditory tracts, often associated with a peripheral loss of hearing in a certain spectral region, which is erroneously interpreted by the brain as an acoustic sensation.

It is known that the symptomatology of tinnitus is often associated with serious damage to the structures and functionality of the ciliate epithelium in the frequency region of the cochlea in which an auditory deficit has developed at a central level.

The physiological mechanisms and persistence of the sensation of tinnitus have still not been clarified even today. For this reason at present there is no effective treatment of tinnitus.

It is known to use some medicines, such as for example lidocaine, which has a temporary inhibitory effect on tinnitus, but these have important collateral effects which prevent any frequent and prolonged use thereof.

States of anxiety and depression, which often accompany tinnitus and which are the main cause of incapacitation of the patient, can be mitigated by means of appropriate psychological therapies, accompanied by the use of anxyolitic drugs, anti-depressants and counselling sessions.

A solution is also known in which musical sounds or pleasant noises are administered to the patient, which help to distract his attention from the tinnitus: this proves the strong psychological component associated with tinnitus. This has led to the development of what is known as sound therapy, officially recognized for treating tinnitus (TRT; Tinnitus Retraining Therapy), which provides to use portable players which generate wide-band white noise.

Prior art documents, such as U.S. Pat. No. 5,403,262, WO-A1-01/70110, WO-A1-2005/053533 and GB-A-2.235.349 all disclose techniques in which a noise, for example a white noise, is generated which comprises frequencies including the dominant frequency of tinnitus, in order to obtain a masking effect of the tinnitus itself by the perception of this noise.

These known therapies bring some relief for the patient, for example greater tolerance of the complaint and consequent improvement in the quality of life, but not an objective and substantiated reduction of the symptom. In various cases, moreover, intolerances occur for the acoustic prostheses used to reproduce sound (noise generators), presumably due to the annoyance caused by the stimulation of the patient with frequencies identical to those of tinnitus. This factor has been the decisive element for the development and perfection of a new sound therapy for treating tinnitus.

Purpose of the present invention is to achieve a device for treating tinnitus that allows to reduce objectively, ideally even to annul the tinnitus, in a quick, economical and non-invasive manner for the patient.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a device according to the present invention is able to be used for treating tinnitus.

According to the present invention, the device comprises generator means, able to generate an audio signal, for example comprising white noise and/or natural sounds, and transducer means, such as for example a pair of ear-phones, connected to the generator means in order to reproduce the audio signal.

According to a characteristic feature of the present invention, the device also comprises filter means interposed between the generator means and the transducer means in order to filter, or substantially suppress, the audio signal in correspondence with an interval of frequencies around the dominant frequency of tinnitus, so as to obtain a silent window (silent band) having a selected width or amplitude around said dominant frequency of tinnitus, so that the transducer means receive the audio signal filtered by the filter means.

According to the present invention, the filtered audio signal allows to stimulate the peripheral auditory organ and the ascending auditory tracts, possibly as far as the cerebral cortex, only in frequency regions that are different from those of tinnitus and from those immediately adjacent to the dominant frequency of tinnitus. In this way, the present invention allows to obtain the following advantages:
distractive effect: the patient is distracted from his tinnitus by using an advantageously neutral audio signal (for example white noise), highly tolerable, which can diminish the perception of tinnitus during listening by exploiting the phenomenon of remote masking;
acoustic rest in and around the tinnitus region: creation of a silent window (silent band) in the spectrum of the audio signal in order to prevent excessive stimulation of the auditory periphery in the tinnitus region (often associated with peripheral damage in the same region), to which stimulation corresponds hypoacusia or hearing loss and the presence of tinnitus at a central level;
neural reorganization: the stimulation of neuronal populations surrounding the tinnitus zone whose activity is responsible for the changed activity of the region of the cerebral cortex in which the sensation of tinnitus develops.

According to an advantageous solution of the present invention, the generator means and/or the filter means are able to keep the filtered audio signal at a level substantially similar to the subjective intensity of the tinnitus.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic view of a device for the treatment of tinnitus according to the present invention;

FIG. 2a shows a filter window for the treatment of tinnitus;

FIG. 2b shows the trend of audiometric measurements based on which the filter window in FIG. 2a is determined;

FIG. 3 shows the trend of the average values of the variations in intensity of the tinnitus in patients subjected to three different sound therapies;

FIG. 4 shows a graph indicating the percentages of withdrawals and cures in patients subjected to the three sound therapies in FIG. 3;

FIG. 5 shows the trend of the average values of the variations in intensity of the tinnitus in patients subjected to the three sound therapies in FIG. 3, calculated in three successive time classes; and

FIG. 6 shows an accumulated distribution of the frequency classes of the absolute values of the differences in the dominant frequency of tinnitus between the initial examination and the check-up after the first month of treatment.

### DETAILED DESCRIPTION OF A PREFERENTIAL FORM OF EMBODIMENT

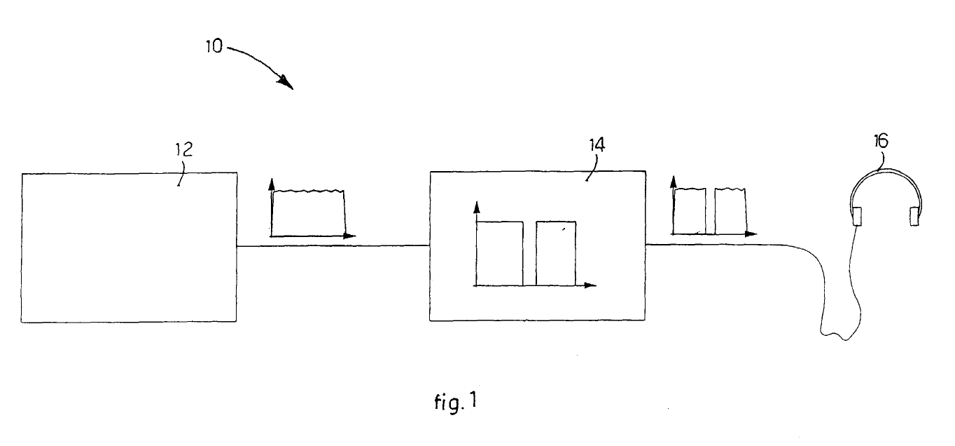

With reference to FIG. 1, a device 10 according to the present invention is able to be used for the treatment of tinnitus, having a determinate subjective intensity (loudness LDN) and a determinate height or dominant frequency (pitch).

According to the present invention, the device 10 comprises:
an audio generator 12, able to generate an audio signal, for example comprising white noise;
an electronic filter 14, connected to the audio generator 12 and suitable to suppress, or attenuate, one or more frequency bands, each having a selectively variable central frequency and a band amplitude also selectively variable;
an acoustic transducer 16, in this case a pair of ear-phones, connected to the electronic filter 14 to reproduce the filtered audio signal.

According to the present invention the electronic filter 14 is configured to filter, or substantially suppress, the audio signal in correspondence with a selected (i.e. having a selected width or amplitude) interval around the dominant frequency of tinnitus.

The device 10 pre-supposes that every patient will be subjected to an audiometric test, to determine the measurement of the fundamental parameters of the tinnitus, that is, the subjective intensity, and the dominant frequency. The measurements are carried out, for example, following the following standard procedures of clinical examination:
audiogram: the absolute hearing thresholds are determined with a standard method (tonal stimulation in the band from about 125 Hz to about 15 kHz);
localization: the patient verifies on which side he perceives the tinnitus (only in the right ear, only in the left ear, bilaterally symmetrical or asymmetrical), since the measurement of tinnitus advantageously provides acoustic stimulation of the patient contralaterally in order to prevent interference between the perception of tinnitus and external sound; and
estimate of the subjective intensity, effected in audiometry using tonal stimuli, or narrow band noise NBN) of ⅓ of an octave, with frequency characteristics similar to those of tinnitus, in the patient's opinion.

Once the appropriate stimulus has been identified, its intensity is increased by passes of 1 dB, from level 0 dB to mixing point, that is, when there is substantial equality between the subjective intensity of the tinnitus and the external stimulus. This value is expressed in dB.

Given that said measurements are performed audiometrically, the frequencies used to estimate the subjective intensity, although similar to the dominant frequency of tinnitus according to the patient, may differ from those identified for the precise evaluation of the dominant frequency of tinnitus obtained separately by the signal generator.

Advantageously, an audiometer is used with high resolution and wide frequency range, that is, from about 125 Hz to about 16 kHz. Once the intensity of the stimulus (in dB) has been identified, the actual subjective intensity of the tinnitus (dBt) is determined, subtracting from the dB of the external stimulus those of the patient's absolute auditory threshold, at that frequency (when available). In the case of stimulation with narrow-band noise, this is not possible, since the auditory thresholds are determined by tonal stimuli. However, an evaluation of the variation in subjective intensity of tinnitus of the same patient in the course of subsequent check-ups is always possible, since the central frequency of the stimulus of the narrow-band noise used to determine the subjective intensity is the same in the different sessions. The same principle obviously applies for the estimate of the variations in subjective intensity with tonal stimulation. These variations in dB of the intensity of tinnitus compared with the initial measurement, indicated by the symbol ΔdBt both in the case of measurements with tonal stimuli and also with measurements with stimuli of narrow-band noise, represent the measurement used to evaluate the efficiency of the sound therapies.

Therefore, a negative ΔdBt value indicates an improvement, whereas a positive value indicates a worsening in the intensity of tinnitus (dB).

We shall now describe a method according to the present invention to determine the dominant frequency of tinnitus, which allows a more exact evaluation of this parameter, compared with current clinical procedures.

A generator of tonal signals was used, connected to a switch device, in turn connected at outlet with a pair of head-phones, advantageously of the type fitting over the ears of the wrap-around type. The estimate is obtained by administering (contralaterally or bilaterally) pure tones the intensity of which is regulated by the patient substantially to the same level as his tinnitus. The tonal stimulation is performed irrespectively of the patient's type of tinnitus.

On the other hand it is possible to use tonal stimulation for measuring the dominant frequency of tinnitus also for noise-type tinnitus, especially in the case of high-frequency tinnitus.

The method followed to identify the dominant frequency (defined by the “forced choice between two selected alternatives”) differs, however, from the standard one (method of the “forced choice between two alternatives”) since it is more exact and reliable.

The method according to the present invention, that is, the forced choice between two selected alternatives, comprises two steps.

In the first step (tonal selection), the frequencies (pure tones) are presented to the patient in a continuous progression, first rising, starting from about 50 Hz up to about 15 kHz and then descending, that is, from about 15 kHz to about 50 Hz. The tonal modulation rate (that is, the increase or decrease in the frequency over time) is kept low, so as to allow the patient both to be able to regulate with ease the intensity of the stimulus and keep it as constant as possible for the duration of the test, and also to compare it with the dominant frequency of his tinnitus. The tonal progression is temporarily stopped every time the patient reports a correspondence between the tone and the dominant frequency of his tinnitus. The value of the last frequency is noted and the tonal progression is restarted from the frequency at which it had been interrupted, and the test to search for the dominant frequency continues. Usually patients identify more than one frequency as similar to their tinnitus, both in the rising progression and in the descending progression. By putting together the frequencies identified by the patient in the two tonal progressions and ordering them according to a rising succession, from the lowest to the highest, we obtain a sequence of values (which we shall indicate Fi, i=1,2,3 . . . n, where n is the last frequency identified) used for a finer identification of the dominant frequency.

In the second step (binary choice), the patient is again asked which of the frequencies Fi previously identified is most similar to his tinnitus. To this purpose the frequencies Fi are compared in pairs, starting from the low tones: the patient is asked to choose which frequency of the first pair (that is, F1 and F2) is more similar to his tinnitus. It often happens that the patient is not able to choose between two frequencies when these are of similar tone, presumably because they fall in the same critical band. This may happen frequently, since the patient had previously identified a similar frequency both in the rising progression and also in the descending progression inside a restricted frequency range. In these cases, the operator varies continuously the knob of the frequency generator inside this frequency range in order to better identify the tone most similar to the dominant frequency of the tinnitus.

This value (F1 or F2 or an intermediate one) is then compared with the immediately subsequent frequency (F3), again verifying with the patient which of the two is nearer his tinnitus. This procedure is competed when the frequency identified up to that point is compared with the frequency identified of highest tonality (Fn).

This second step of identifying the dominant frequency resembles the traditional or standard step of forced binary choice. However, it differs from the latter in that the choice of the frequencies compared is determined by the patient himself in the first step (while it is fixed in the standard method), and the comparison continues until the highest frequency previously identified by the patient (whereas in the standard method it is interrupted when there is a frequency which in the binary comparison is preferred to those of immediately upper and lower tonality).

The present invention also concerns a method to use the device 10.

The method comprises a treatment step, in which a sequence of white noise is generated by the audio generator 12 and filtered by the electronic band-erased filter 14.

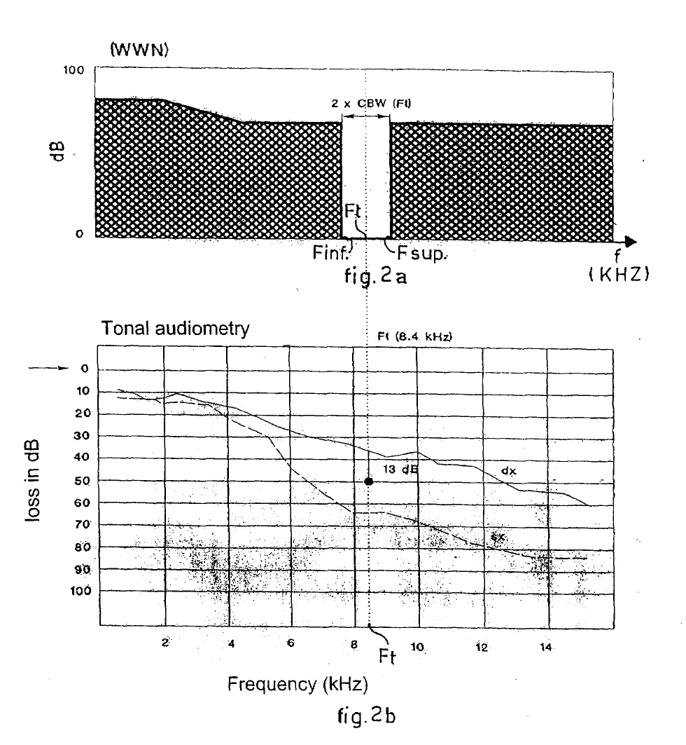

In particular in FIGS. 2a and 2b, an example is shown of how to determine the window (silent band) in the spectrum of equalized white noise (WWN spectrum, FIG. 2a) where the center band value of the electronic filter 14 is given by Ft (determined according to the audiometric measurements reported in the graph in FIG. 2b), and whose band amplitude [Finf, Fsup] (that is, its extremes in frequency: lower Finf and upper Fsup) are determined in relation to the width of the critical band (critical bandwidth, or CBW) at that frequency Ft.

In FIGS. 2a and 2b it is supposed that the value of Ft determined audiometrically coincides with the one determined with the method of forced choice between two selected alternatives. The estimate of the subjective intensity of tinnitus is determined by subtracting the value in dB of the reference tone from the absolute ipsilateral threshold (dx=right, sx=left) of the patient at that frequency. In this example the subjective intensity is 13 dB.

In general, the critical band of a determinate tonal frequency is that auditory region around the tonal frequency inside which the noise may mask the perception. The amplitude of CBW thus increases as the frequency increases. The idea is to eliminate from WN stimulation not only the frequencies near to Ft but also those which fall inside its critical band. It has been hypothesized that tinnitus may typically consist of a dominant frequency and complex spectrum, more or less extensive, around it. On this point it should be considered that the estimate of dominant frequency by means of tonal comparison is subject to error, for reasons that do not only depend on the training of the patient, or the perceptual uniqueness of tinnitus. For example, it is difficult to discriminate between nearby frequencies if, when used in estimating the dominant frequency, they fall inside its critical band.

Moreover, other phenomena, such as the subjective increase in the frequency value of a tonal stimulus as its intensity increases can increase the error of the estimate.

For these reasons, the amplitude of the band-erased filtering of the electronic filter 14 is fixed at a double CBW value. In other words, the sequence of white noise is filtered by the electronic filter 14 with an amplitude of 2×CBW[Ft], centered on Ft (where CBW[Ft] is the amplitude of the critical band corresponding to the central frequency Ft). These sequences are indicated by the acronym WWN.

There is a double purpose to this treatment: on the level of the central nervous system (SNS), to avoid as far as possible administering frequencies similar to tinnitus (or near the dominant frequency or, in any case, which fall inside its critical band) which would exacerbate the perception thereof and the sensation of annoyance; on a peripheral level, to avoid the mechanical stimulation of the auditory region of the cochlea in which the tinnitus developed, presumably affected by partial damage to the ciliate cells.

To verify the effectiveness of the sound therapy proposed in the treatment of tinnitus, two types of control stimulation were used: white noise WN and natural sounds Wa, such as those generated by a stream of water.

According to the invention, stimulation with white noise WN consists of a sequence of about 8 minutes of white noise WN which comprises all the frequencies in the range of about 50 Hz to about 16 KHz (that is, the range of normal human hearing). The sequence of white noise WN is filtered and equalized by the electronic filter 14 in order to compensate the fall in sensitivity at low frequencies of the ear-phones (FIG. 2a).

The purpose is to provide the patient with an acoustic stimulation of the cochlea as uniform as possible, independently of the subjective auditory sensitivity. A possible alternative to stimulation with uniform white noise WN is to administer equalized white noise according to the patient's auditory curve, so as to provide an acoustic stimulation such as to allow the patient to perceive all the frequencies of noise approximately at the same intensity. This solution entails the construction of personalized equalization curves for each patient.

Stimulation with water consists of a sequence Wa of underwater noise, lasting about 8 minutes.

These two types of acoustic stimulation are used to elaborate on the one hand the experimental sound treatment by means of the device 10, and on the other hand the control treatments used in order to demonstrate the therapeutic effectiveness thereof.

The sequences are advantageously recorded on a support, such as for example a compact disk, easily used by the patient. The patient, by means of a suitable CD reader, uses ear-phones having a specific frequency response curve, based on which the WWN and WN sequences are equalized.

The sound therapy consists of listening to the passage every day for a period of about 1.5 to about 3 hours, with a listening volume such as to level the subjective intensity of the passage approximately to that of tinnitus.

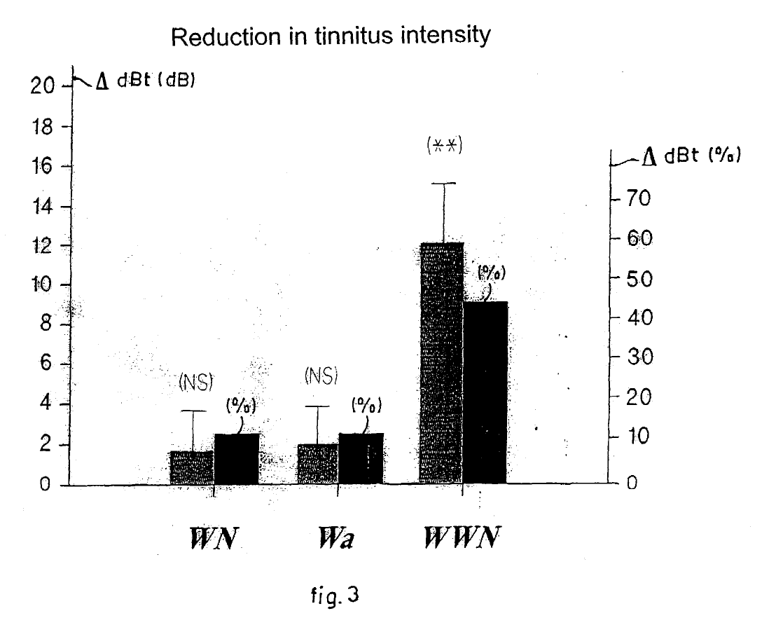

The improvements achieved by the patients after listening to the experimental WWN sound therapy and control sound therapies WN and Wa are summarized in FIGS. 3, 4 and 5.

The graph in FIG. 3 shows, for each type of sound therapy, the average of the ΔdBt values, in absolute form (gray columns) or percentage form (black columns), calculated on the date of the last check-up made by each patient. Since the average is always negative in each treatment (that is, since the average variation in the intensity of the tinnitus is in the direction of improvement) the sign of the ΔdBt values has been changed and reported in the graph with a relative reduction (absolute or percentage) in the intensity of the tinnitus (dB).

As can be seen, while the patients subjected to the two control treatments show, on average, very modest improvements and, in any case, not significantly different from 0 (note the standard error which is positioned above the zero line), those treated with the WWN treatment show considerable improvement which, expressed as a percentage, corresponds on average to a 40% reduction in intensity of tinnitus compared with the initial value (dBt₀). These average values correspond to a period of average use of 148 (±20), 145 (±25) and 127 (±16) days, respectively for the WN, Wa and WWN treatments (that is, periods of time comprised between 4 and 5 months).

The results of analyzing the non-parametric variance have shown how there are statistically significant differences between the three treatments in the average ΔdBt value, both as absolute value (t=12.7, p=0.0018, n=43) and as percentage value (t=6.8, p=0.03, n=35). On the contrary, no statistically significant differences emerged in the average value of days between the three treatments (t=0.42, NS, n=43).

Moreover, the patients in the three groups do not show any significant difference in the average dBt₀ value (t=3.7, NS, n=35). The smaller number of data relating to the percentage values is explained by the fact that in some patients the intensity of the tinnitus was evaluated using stimulation with narrow-band noise and therefore it was not possible to calculate dBt₀.

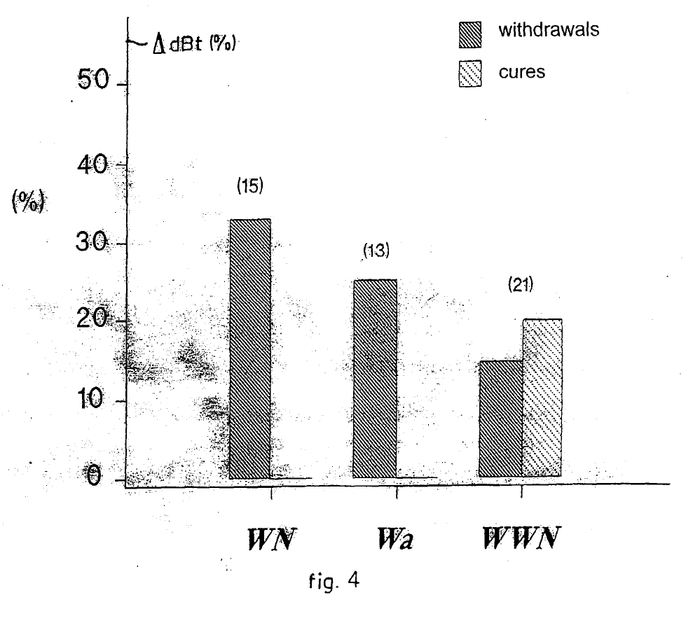

It can also be seen in FIG. 4 how a certain percentage of patients in all three categories of treatment abandoned the therapy. Out of six patients, four of whom had WN, one had Wa and another WWN, this happened before the date of the first check-up. Therefore, these patients do not appear in the previous analyses since they have only the initial measurement of tinnitus (dBt₀). As can be seen from the graph, which shows the percentages of withdrawals from the therapy calculated including these patients too in the overall count for each treatment group, the highest withdrawal percentages occurred in the two groups of patients with control treatment, the lowest (15%) in the experimental group. On the contrary, all the completely cured patients (that is, in whom the tinnitus was not measurable since it was not perceived by the patient) came within the group with experimental treatment, with a proportion of 1 out of 5 (20%).

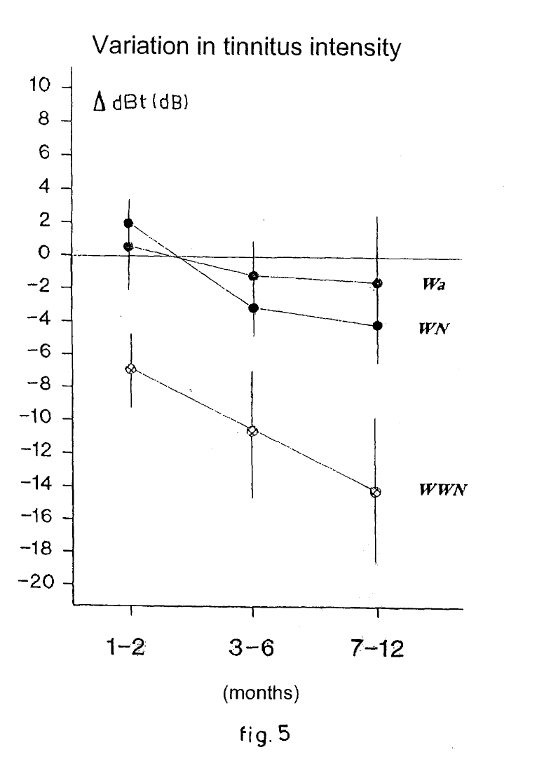

The results of the effectiveness of the three types of sound therapy according to the time of use are shown in FIG. 5. As can be seen from the graph, the patients subjected to experimental WWN sound treatment show on average a considerable reduction in the intensity of the tinnitus right from the first months (average ΔdBt: from −6 to −7 dB), a reduction that is more appreciable as the time of use passes, until it reaches about −13 dB when the therapy continues for more than 6 months from the beginning of the treatment.

Moreover, these average improvements are all significantly different from 0, as can be seen by observing the entity of the standard error associated with each average value. On the contrary, the patients subjected to control sound treatment WN or Wa do not show, on average, obvious variations in the intensity of the tinnitus after 1-2 months, whereas there is a slight objective reduction in the intensity of the tinnitus over longer times, more evident in the patients subjected to WN therapy (average ΔdBt: −4 dB, for times longer than 6 months).

In any case, the average variations in the three periods of time are not significantly different from 0, as can be observed from the entity of the standard error, which intercepts or is near to the line of zero.

The results of the test to analyze the non-parametric variance confirmed the visual analysis, that is, the average ΔdBt value varied significantly between the three treatments in the first two months (t=7.9, p=0.019, n=37), in the following 3-6 months (t=7.2, p=0.028, n=32) whereas there was a tendency to differ in the 7-12 months (t=5.2, p=0.07. n=13). This last result is explained by the too low number of patients evaluated at a distance of time of more than 6 months (WN: n=4, Wa: n=4, WWN: n=5) to obtain a detailed statistical analysis.

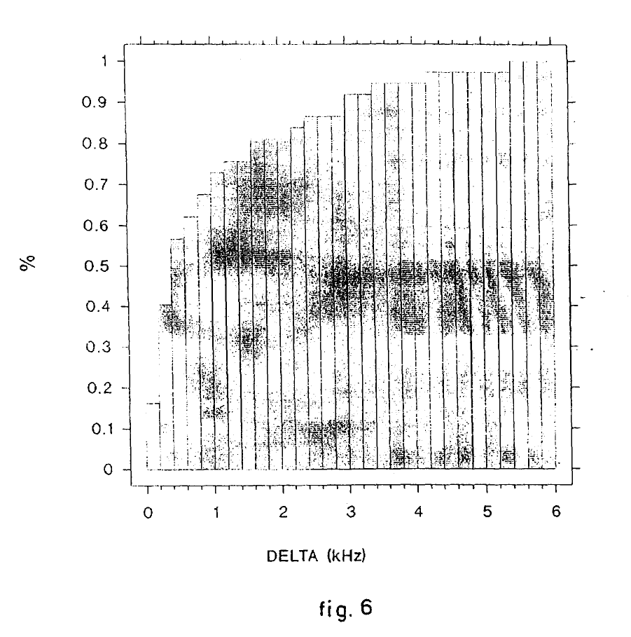

FIG. 6 shows the accumulated distribution of the relative frequency of the frequency classes of the absolute values of the differences in the dominant frequency of tinnitus between the initial examination and the check-up after the first month of treatment, that is |Ft₁−Ft₀| (DELTA), in kHz, where Ft₀ is the initial estimate of the dominant frequency, while Ft₁ is that of the first check-up. As can be seen from the graph, more than ⅔ of the differences calculated is confined in the classes comprised between 0 and 1 kHz, and about ½ is equal to or less than 0.6 kHz.

The average of the absolute values of the differences in the dominant frequency is 1.1 kHz, a value much lower than most variability estimates, both between different sessions and also inside the same session, as reported in literature. Moreover, the times used to determine Ft, as was discussed previously, are largely those reported in literature following other evaluation procedures. It must be underlined that the average value of absolute difference in the dominant frequency between sessions has a purely indicative value, given that the distribution of the differences of the dominant frequency is extremely asymmetrical on the right and similar in profile to a negative exponential. In reality, what is most interesting for the purposes of this study is to know if successive estimates of the dominant frequency are sufficiently near the initial one, Ft₀, as to fall inside the spectral zone which, in the WWN sequence, is windowed with the electronic filter 14 in correspondence with Ft₀.

In other words, given that in the WWN sequence the amplitude of the window in the noise made around Ft₀ is 2×CBW[Ft₀], we have to see whether the values of |Ft₁−Ft₀| are in most cases equal to or less than the amplitude of the critical band of Ft₀. The analysis has shown how this occurs in about ⅔ of the values of |Ft₁−Ft₀| calculated overall, without considering the type of sequence administered to the patient (n=41). We must specify that these differences were calculated between estimates of the dominant frequency determined at a distance of at least one month one from the other. They are therefore affected not only by the presence of possible errors of measurement, but also possible time variations in the dominant frequency of the tinnitus of the same patient between successive sessions.

In conclusion, the present invention shows itself to be suitable not only to estimate with a certain reliability the dominant frequency of tinnitus, but also to be able to apply the experimental treatment proposed with equal reliability.

The device 10 allows to obtain the following results:
improvement in the symptom: the experimental results have shown a substantial and objective therapeutic effectiveness (reduction in the perception of tinnitus, expressed in dB), compared with traditional methods of sound therapy;
speed of improvement: significant results are obtained with this new method already in the first two months of treatment, compared to the eighteen months necessary in the official Tinnitus Retraining Therapy to achieve only the adaptation of the patient to tinnitus;
good tolerability of the treatment: the data concerning withdrawal rates by patients clearly show that the new therapy has a level of tolerability higher than the stimulations with simple white noise and with water; and
economy of the treatment: another important feature is that our treatment is inexpensive, since it does not include the use of acoustic prostheses.

It is clear that modifications and/or additions of parts may be made to the device 10 as described heretofore, without departing from the field and scope of the present invention. For example, it is possible to implement the technique of acoustic stimulation by using other devices, such as MP3 readers, I-Pod® or, ideally, programmable digital generators that the patient can wear.

It is also clear that, although the present invention has been described with reference to some specific examples, a person of skill in the art shall certainly be able to achieve many other equivalent forms of device for treating tinnitus, having the characteristics as set forth in the claims and hence all coming within the field of protection defined thereby.

1. A device for the treatment of tinnitus, comprising generator means able to generate an audio signal, and transducer means connected to said generator means in order to reproduce said audio signal, wherein said audio signal is selected between one of white noise and natural sound, the device also comprising filter means interposed between said generator means and said transducer means in order to filter and substantially suppress said audio signal at least in correspondence with an interval of frequencies around the dominant frequency (Ft) of tinnitus, so as to obtain a silent window (silent band) having a selected width or amplitude around said dominant frequency (Ft) of tinnitus, and wherein said transducer means receives the audio signal filtered by said filter means.

2. The device as in claim 1, wherein said silent window has an amplitude corresponding to 2×CBW[Ft], centered on Ft, wherein CBW[Ft] is the amplitude of the critical band corresponding to the central frequency Ft, and wherein the critical band is that auditory region around the tonal frequency inside which the noise may mask the perception.

3. The device as in claim 1, wherein said generator means and said filter means are able to keep the filtered audio signal at a level substantially equal to the subjective intensity of tinnitus.

4. The device as in claim 1, wherein said filter means is able to equalize said audio signal at least as a function of the frequency response of said transducer means.

5. The device as in claim 1, wherein said filter means is able to equalize said audio signal at least so as to be able to stimulate uniformly the inner ear.

6. The device as in claim 1, wherein said transducer means is able to be worn by a patient, and wherein said transducer means is able to reproduce said filtered audio signal in the patient's ear opposite the ear where the tinnitus is present in contralateral mode.

7. The device as in claim 1, wherein said transducer means is able to be worn by a patient, and wherein said transducer means is able to reproduce said filtered audio signal in the patient's ear where the tinnitus is present.

8. The device as in claim 1, wherein said transducer means is able to be worn by a patient, and wherein said transducer means is able to reproduce said filtered audio signal in both the patient's ears in bilateral mode.

9. The device as in claim 1, wherein said audio signal has a frequency band comprised between about 20 Hz and about 20 kHz.

10. A method for the treatment of tinnitus, comprising a step in which generator means, able to generate an audio signal, generates a sequence of white noise or natural sound, and wherein said sequence is filtered by electronic band-erased filter means so as to obtain a silent window (silent band) having a selected width or amplitude around the dominant frequency of tinnitus (Ft).

11. The method for the treatment of tinnitus as in claim 10, wherein the amplitude of the filtering of said electronic band-erased filter means corresponds to 2×CBW[Ft], centered on Ft, wherein CBW[Ft] is the amplitude of the critical band corresponding to the central frequency Ft, and wherein the critical band is that auditory region around the tonal frequency inside which the noise may mask the perception.
